(19) United States
(12) Patent Application Publication
(10) Pub. No.: US 2017/0167852 A1
(43) Pub. Date: Jun. 15, 2017

(54) OPTICAL MEASURING METHOD AND MEASURING APPARATUS FOR EXTERNAL DIMENSION

(71) Applicant: MITUTOYO CORPORATION, Kanagawa (JP)

(72) Inventor: Yutaka MIKI, Machida (JP)

(73) Assignee: MITUTOYO CORPORATION, Kanagawa (JP)

(21) Appl. No.: 15/376,934

(22) Filed: Dec. 13, 2016

(30) Foreign Application Priority Data
Dec. 15, 2015 (JP) 2015-244239

(51) Int. Cl. G01B 11/02

(52) U.S. Cl. CPC G01B 11/028

(57) ABSTRACT

A light emitter and a reflector are placed such that an optical axis of a measuring light beam and an optical axis of a reflection light beam intersect, and further the measuring light beam and the reflection light beam are formed inside the same virtual measuring plane; a first measuring light beam and a second measuring light beam are defined in the measuring light beam, a first and second reflection light beam are defined in the reflection light beam, a measured object is placed in a measuring region on a measuring plane where the first and second measuring light beams overlap, an external diameter of the measured object in a first direction is measured from a shadow appearing in the first reflection light beam and an external diameter of the measured object in a second direction is measured from a shadow appearing in the second reflection light beam.

### CROSS-REFERENCE TO RELATED APPLICATIONS

The present application claims priority under 35 U.S.C. §119 of Japanese Application No. 2015-244239, filed on Dec. 15, 2015, the disclosure of which is expressly incorporated by reference herein in its entirety.

### BACKGROUND OF THE INVENTION

1. Field of the Invention

The present invention relates to an optical measuring method and measuring apparatus for an external dimension, and relates to a method and an apparatus measuring outer diameters of a measured object in a plurality of directions simultaneously.

2. Description of Related Art

Optical measuring apparatuses are used in order to conduct non-contact measurement of an external dimension of a measured object (such as an outer diameter of a cylindrical object). For example, a laser scan micrometer, image sensor micrometer, or light-section type 2D (two dimensional) shape measuring sensor is used. These apparatuses detect the outer diameter of the measured object from dimensions of shaded sections blocked by the measured object, using a parallel laser light beam arranged in a band shape or a laser beam parallel scanning in a band shape, or the like (see Japanese Patent Laid-open Publication No. 2001-108413 and the like).

As shown in FIG. 5, in a laser scan micrometer 90, a laser light beam B in a band shape is formed by a light emitter 91 and the light beam B is received with a photoreceiver 92. When a measured object 99 having a cylindrical shape or the like is placed in the middle of a path of the light beam B, a portion of the light beam B is blocked by the measured object 99 and a shadow region BW is formed behind the measured object 99. In the photoreceiver 92, an outer diameter D1 of the measured object 99 can be measured by detecting a length of the shadow region BW created in the light beam B.

When the outer diameter of the measured object 99 must be measured in a plurality of directions simultaneously, a dedicated laser scan micrometer is used. As shown in FIG. 6, a laser scan micrometer 93 for measuring an object in two directions simultaneously is configured with two sets of light emitters 94 and 95 and photoreceivers 96 and 97 arranged in mutually intersecting directions. In such a configuration, based on the light beam from each set, outer diameters D1 and D2 of the measured object 99 can be measured simultaneously in two directions.

As described above, the optical measuring apparatuses such as the existing laser scan micrometer basically measure the external dimension of the measured object in a single direction and a plurality of sets of a light emitter and a photoreceiver are required to perform simultaneous measurements in a plurality of directions. However, when a plurality of sets of light emitters and photoreceivers are installed, a cost of a device may increase and a space to install all the sets may expand as well.

### SUMMARY OF THE INVENTION

The present invention provides an optical measuring method and measuring apparatus for an external dimension which allow simultaneous measurements in a plurality of directions and can prevent a cost increase of a device and an expansion of an installation space.

The measurement method of the present invention is an optical measurement method for an external dimension measuring an external dimension of a measured object. In this method, a light emitter forming a measuring light beam in a band shape which is configured by parallel light beams, a reflector reflecting the measuring light beam and forming a reflection light beam, and a photoreceiver receiving the reflection light beam are arranged; the light emitter and the reflector are placed so that an optical axis of the measuring light beam and an optical axis of the reflection light beam intersect, and in addition, the measuring light beam and the reflection light beam are formed inside the same virtual measuring plane; at least a main measuring light beam and a sub measuring light beam are defined in the measuring light beam; at least a main reflection light beam which is reflected light of the main measuring light beam and a sub reflection light beam which is reflected light of the sub measuring light beam are defined in the reflection light beam; the measured object is placed in a measuring region on the measuring plane where the main measuring light beam and the sub reflection light beam overlap; and the external dimension is measured in a main direction of the measured object from a shadow of the measured object appearing in the main reflection light beam and also the external dimension is measured in a sub direction of the measured object from the shadow of the measured object appearing in the sub reflection light beam.

In the present invention, by a simple configuration with a reflector added to a paired light emitter and photoreceiver, the simultaneous measurement of the external dimension in the main direction and the sub direction of the measured object can be achieved. At this point, the light emitter and the photoreceiver in the existing laser scan micrometer or the image sensor micrometer can be applied for the paired light emitter and photoreceiver. In addition, an existing reflection mirror for optical measurement can be used for the reflector. As described above, according to the present invention, even with a single light emitter and photoreceiver system, simultaneous measurement in a plurality of directions can be achieved and an increase in the cost of the device and an expansion of the installation space can be prevented.

The measuring apparatus of the present invention is an optical measuring apparatus for an external dimension measuring an external dimension of a measured object. In this apparatus, light emitter forming a measuring light beam in a band shape which is configured by a parallel light beam, a reflector reflecting the measuring light beam and forming a reflection light beam, and a photoreceiver receiving the reflection light beam are included; the light emitter and the reflector are arranged such that an optical axis of the measuring light beam and an optical axis of the reflection light beam intersect, and in addition, the measuring light beam and the reflection light beam are formed inside the same virtual measuring plane; at least a main measuring light beam and a sub measuring light beam are defined in the measuring light beam; at least a main reflection light beam which is reflected light of the main measuring light beam and a sub reflection light beam which is reflected light of the sub measuring light beam are defined in the reflection light beam; and the measured object is placed in a measuring region on the measuring plane where the main measuring light beam and the sub reflection light beam overlap.

In the present invention, the external dimension of the measured object in the main direction can be measured from the shadow of the measured object appearing in the main reflection light beam and also the external dimension of the measured object in the sub direction can be measured from the shadow of the measured object appearing in the sub reflection light beam. Therefore, the effects described above can be obtained by performing the measuring method according to the present invention mentioned above.

The present invention enables simultaneous measurement in a plurality of directions and can provide the optical measuring method and the measuring apparatus for the external dimension capable of preventing increased cost in the apparatus and the expansion of the installation space.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a schematic view illustrating an apparatus structure of a first embodiment of the present invention;

FIG. 2 is a graph illustrating a measuring process of the first embodiment;

FIG. 3 is a schematic view illustrating an apparatus structure of a second embodiment of the present invention;

FIG. 4 is a schematic view illustrating an apparatus structure of a third embodiment of the present invention;

FIG. 5 is a perspective view illustrating a conventional external dimension measurement in a single direction; and

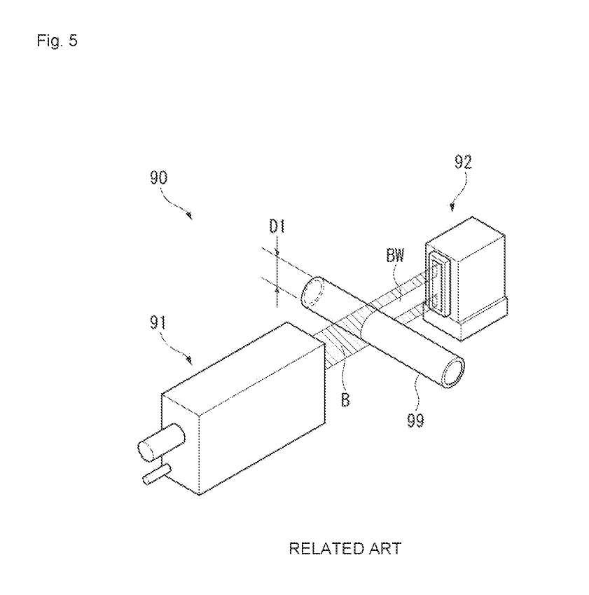

FIG. 6 is a perspective view of a conventional external dimension simultaneous measurement in two directions.

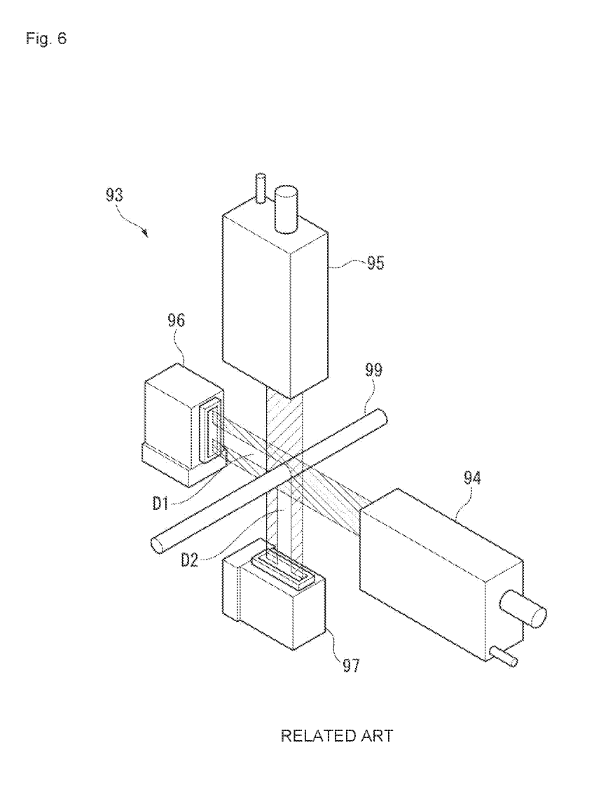

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

### First Embodiment

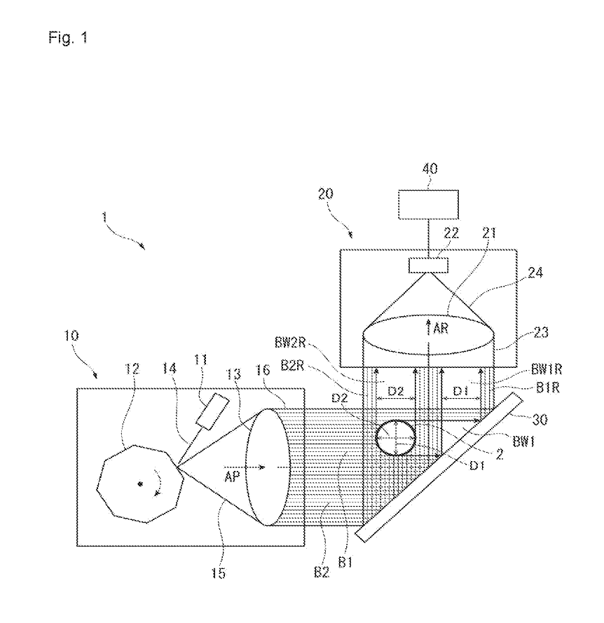

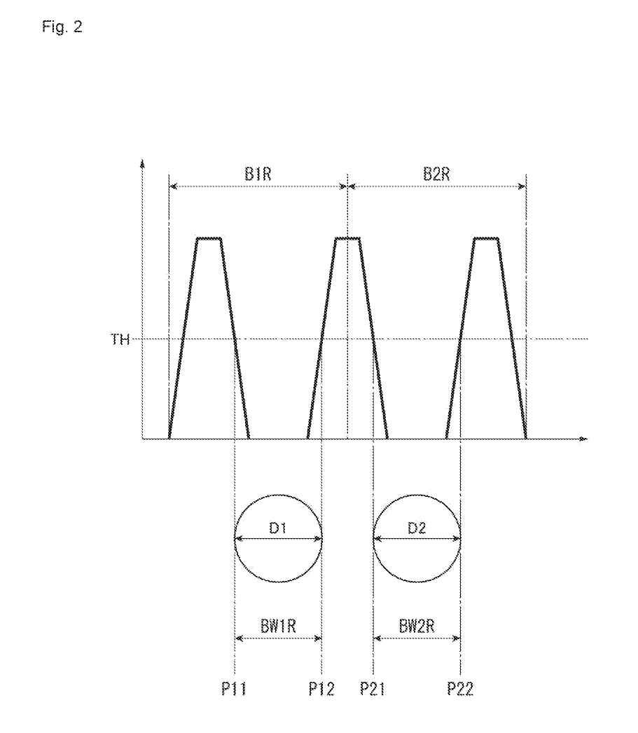

FIGS. 1 and 2 illustrate a first embodiment according to the present invention. In FIG. 1, a measuring apparatus 1 is an optical measuring apparatus for an external dimension based on the present invention and measures an external dimension of a measured object 2. In the present embodiment, the measured object 2 is a bar shaped object having a circular cross-section and extends in a direction perpendicular to a paper surface of FIG. 1. In the present embodiment, the external dimensions (outer diameters D1 and D2) are measured simultaneously in two directions of the measured object 2 using the measuring apparatus 1. The measuring apparatus 1 includes a light emitter 10, a photoreceiver 20, and a reflector 30.

The light emitter 10 includes a laser light source 11, polygonal mirror 12, and a collimator lens 13. In the light emitter 10, beam-shaped laser light 14 from the laser light source 11 is reflected by the polygonal mirror 12. Reflection light 15 is emitted through the collimator lens 13. The polygonal mirror 12 is rotationally driven by a rotation driving mechanism (not shown in the drawings). Accordingly, a beam of the reflection light 15 reflected by the polygonal mirror 12 is oscillated in a fan shape and the beam emitted through the collimator lens 13 is oscillated in parallel, thereby forming a band-shaped measuring light beam 16.

The reflector 30 is configured with a reflection mirror having a highly accurate flat face. The reflector 30 is placed on an optical path of the measuring light beam 16 and forms a reflection light beam 23 by reflecting the measuring light beam 16. In this example, the light emitter 10 and the reflector 30 are arranged such that an optical axis AP of the measuring light beam 16 and an optical axis AR of the reflection light beam 23 intersect at a right angle, and also such that the measuring light beam 16 and the reflection light beam 23 are formed on the same virtual measuring plane (sheet surface of FIG. 1).

In the present embodiment, a direction of the optical axis AP of the measuring light beam 16 (i.e., a left-to-right direction in FIG. 1) is a first direction, and a direction of the optical axis AR of the reflection light beam 23 (i.e., a bottom-to-top direction in FIG. 1) is a second direction.

The photoreceiver 20 includes a collecting lens 21 arranged on the optical path of the reflection light beam 23 and a photoreceiver element 22 arranged at the focal position of the collecting lens 21. In the photoreceiver 20, the reflection light beam 23 from the reflector 30 is converged by the collecting lens 21 and convergence light 24 strikes the photoreceiver element 22. The photoreceiver element 22 detects a light intensity of the convergence light 24 received and outputs the detected light intensity to an exterior control apparatus 40.

Respective portions of the existing laser scan micrometer can be used as the control apparatus 40, the photoreceiver 20, and the light emitter 10. The outer diameters D1 and D2 of the measured object 2 can be measured simultaneously based on a width of a shadow of the measured object 2 appearing in the reflection light beam 23, using existing signal processing.

In the present embodiment, a first measuring light beam B1 and a second measuring light beam B2 are designated in the measuring light beam 16. For example, the first measuring light beam B1 and the second measuring light beam B2 each occupy half of the measuring light beam 16, the first measuring light beam B1 on a first side and the second measuring light beam B2 on a second side. The first measuring light beam B1 and the second measuring light beam B2 are reflected by the reflector 30 and form a first reflection light beam B1R and a second reflection light beam B2R, respectively. In other words, in the reflection light beam 23, the first reflection light beam B1R is designated on one side and the second reflection light beam B2R is designated on the other side.

On the virtual measuring plane noted above, the first measuring light beam B1 emitted from the light emitter 10 is reflected by the reflector 30 and reaches the photoreceiver 20 as the first reflection light beam B1R. In addition, the second measuring light beam B2 emitted from the light emitter 10 is reflected by the reflector 30 and reaches the photoreceiver 20 as the second reflection light beam B2R. In such a measuring plane, the measured object 2 is placed in a measuring region where the first measuring light beam B1 and the second reflection light beam B2R overlap.

The second reflection light beam B2R is emitted in the second direction (optical axis AR direction) from the bottom of FIG. 1 toward the measured object 2 placed in the measuring region, and a shadow BW2R in the second direction is formed by the measured object 2 in the second reflection light beam B2R reaching the photoreceiver 20. In the meantime, the first measuring light beam B1 is emitted toward the measured object 2 in the first direction (optical axis AP direction) from the left side of FIG. 1 and a shadow BW1 is formed in the first measuring light beam B1 reaching the reflector 30. The measuring light beam B1 including the shadow BW1 is reflected by the reflector 30, and a shadow BW1R from the measured object in the first direction is formed in the first reflection light beam B1R reaching the photoreceiver 20.

In the control apparatus 40, the outer diameter D1 of the measured object 2 appearing in the first direction is measured from the shadow BW1R formed in the first reflection light beam B1R. In addition, the outer diameter D2 of the measured object 2 appearing in the second direction is measured from the shadow BW2R formed in the second reflection light beam B2R. In FIG. 1, when the polygonal mirror 12 is rotated clockwise, in the measuring light beam 16, the laser beam displaces in parallel from the upper side of FIG. 1 (first measuring light beam B1 side) to the lower side (second measuring light beam B2 side). In the reflection light beam 23, the laser beam displaces in parallel from the right side of FIG. 1 (first reflection light beam B1R side) to the left side (second reflection light beam B2R side). Therefore, from the photoreceiver element 22 of the photoreceiver 20, a detection signal of the first reflection light beam B1Rt is output followed by the detection signal of the second reflection light beam B2R.

In FIG. 2, the detection signal from the photoreceiver element 22 which is sent to the control apparatus 40 includes three peak portions. Among them, a left peak and a left half of a center peak in FIG. 2 are the detection signal of the first reflection light beam B1R, and a right peak and a right half of the center peak in FIG. 2 are the detection signal of the second reflection light beam B2R. In addition, a valley between the left peak and the center peak in FIG. 2 is the shadow BW1R of the measured object 2 in the first direction appearing in the first reflection light beam B1R, and a valley between the right peak and the central peak in FIG. 2 is the shadow BW2R of the measured object 2 in the second direction appearing in the second reflection light beam B2R. By trimming the detection signal with a predetermined threshold value TH, the control apparatus 40 determines end points P11, P12, P21, and P22 of the shadows BW1R and BW2R of the measured object 2. As a result, based on a distance between the end points P11 and P12, and a distance between the end points P21 and P22, the outer diameter D1 in the first direction and the outer diameter D2 in the second direction of the measured object 2 can be measured simultaneously.

According to the present embodiment, by a simple configuration with the reflector 30 added to the paired light emitter 10 and photoreceiver 20, the outer diameters D1 and D2 of the measured object 2 can be measured simultaneously in the first direction (optical axis AP direction) and the second direction (optical axis AR direction). At this point, a light emitter and a photoreceiver in the existing laser scan micrometer can be applied as the paired light emitter 10 and photoreceiver 20. In addition, the existing reflection mirror can be used as the reflector 30 and no special equipment is required. As described above, according to the present invention, with only a single system having the light emitter 10 and the photoreceiver 20, the outer diameters D1 and D2 can be measured simultaneously in a plurality of directions, and in addition, an increase in the cost of the device and in the installation space can be prevented.

Further, in the present embodiment, the first direction (optical axis AP direction) is a main direction in the present invention; the first measuring light beam B1 is a main measuring light beam of the present invention; the first reflection light beam B1R is a main reflection light beam of the present invention; the second measuring light beam B2 is a sub measuring light beam of the present invention; and the second reflection light beam B2R is a sub reflection light beam of the present invention.

### Second Embodiment

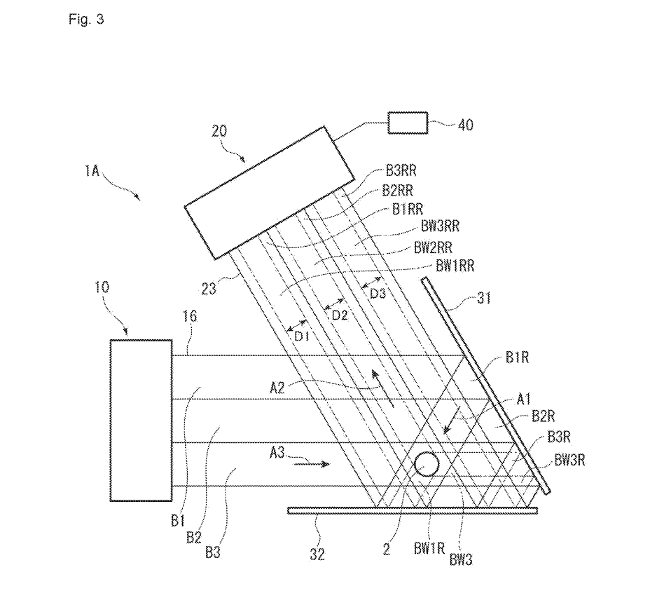

FIG. 3 illustrates a second embodiment according to the present invention. A measuring apparatus 1A of the second embodiment includes the light emitter 10, the photoreceiver 20, and the control apparatus 40 similar to the measuring apparatus 1 in the first embodiment described above. However, two reflection mirrors 31 and 32 are used as the reflector and three regions are assigned to the measuring light beam 16 and the reflection light beam 23.

The two reflection mirrors 31 and 32 are arranged mutually forming a 60 degree angle. The measuring light beam 16 from the light emitter 10 is arranged parallel to a surface of the second reflection mirror 32 and strikes the first reflection mirror 31 at a 60 degree angle. The light beam reflected by the first reflection mirror 31 is sent to the second reflection mirror 32 and is further reflected to form the reflection light beam 23. The reflection light beam 23 proceeds parallel to the surface of the first reflection mirror 31 and strikes the photoreceiver 20.

The measuring light beam 16 from the light emitter 10 is divided into the first measuring light beam B1, the second measuring light beam B2, and a third measuring light beam B3 in order from top to bottom in FIG. 3. The optical axis of the first measuring light beam B1, the second measuring light beam B2, and the third measuring light beam B3 is a third direction A3. The first measuring light beam B1, the second measuring light beam B2, and the third measuring light beam B3 are reflected individually by the first reflection mirror 31 to create the first reflection light beam B1R, the second reflection light beam B2R, and a third reflection light beam B3R respectively. The optical axis of the first reflection light beam B1R, the second reflection light beam B2R, and the third reflection light beam B3R is the first direction A1. Further, the first reflection light beam B1R, the second reflection light beam B2R, and the third reflection light B3R are each individually reflected by the second reflection mirror 32 to create a first re-reflected light beam B1RR, a second re-reflected light beam B2RR, and a third re-reflected light beam B3RR respectively. The optical axis of the first re-reflected light beam B1RR, the second re-reflected light beam B2RR, and the third re-reflected light beam B3RR is the second direction A2.

In the present embodiment, the measured object 2 is placed on the optical path of the third measuring light beam B3 and arranged in a measuring region on the optical paths for the second re-reflected light beam B2RR and the first reflection light beam B1R. The first reflection light beam B1R is fired in the first direction A1 at the measured object 2 placed in the measuring region, which forms the shadow BW1R and reaches the photoreceiver 20 as a shadow BW1RR of the first re-reflected light beam B1RR. Further, the measured object 2 forms a shadow BW2RR when struck by the second re-reflected light beam B2RR in the second direction A2 and the shadow BW2RR reaches the photoreceiver 20. Furthermore, the measured object 2 forms a shadow BW3 when struck by the third measuring light beam B3 in the third direction A3 and the shadow BW3 reaches the photoreceiver 20 as a shadow BW3R of the third reflection light beam B3R and as a shadow BW3RR of the third re-reflected light beam B3RR.

As a result, in the reflection light beam 23 received by the photoreceiver 20, the shadows BW1RR, BW2RR, and BW3RR are formed in the first re-reflected light beam B1RR, the second re-reflected light beam B2RR, and the third re-reflected light beam B3RR respectively. Then, it is possible to individually measure the outer diameter D1 in the first direction from the shadow BW1RR, the outer diameter D2 in the second direction from the shadow BW2RR, and an outer diameter D3 in the third direction from the shadow BW3RR.

In the present embodiment, the first direction A1 and the second direction A2 correspond to the main direction and the sub direction of the present invention respectively. In this case, the main measuring light beam of the present invention is the first reflection light beam B1R and the main reflection light beam is the first re-reflected light beam B1RR. In addition, the sub measuring light beam is the second reflection light beam B2R and the sub reflection light beam is the second re-reflected light beam B2RR. The measured object 2 is placed in a measuring region where the optical path of the main measuring light beam (first reflection light beam B1R) and the optical path of the sub reflection light beam (second re-reflected light beam B2RR) overlap. Accordingly, the outer diameter D1 in the first direction A1 and the outer diameter D2 in the second direction A2 are measured.

In the meantime, according to the present embodiment, the third direction A3 and the first direction A1 also correspond to the main direction and sub direction of the present invention respectively. In this case, the main measuring light beam of the present invention is the third measuring light beam B3 and the main reflection light beam is the third reflection light beam B3R. In addition, the sub measuring light beam is the first measuring light beam B1 and the sub reflection light beam is the first reflection light beam B1R. The measured object 2 is placed in the measuring region where the optical path of the main measuring light beam (third measuring light beam B3) and the optical path of the sub reflection light beam (first reflection light beam B1R) overlap. Accordingly, the outer diameter D3 in the third direction A3 and the outer diameter D1 in the first direction A1 are measured. In the present embodiment, in order to measure the outer diameters D1 to D3 in three directions, two sets of the configuration in the present invention are used as described above.

### Third Embodiment

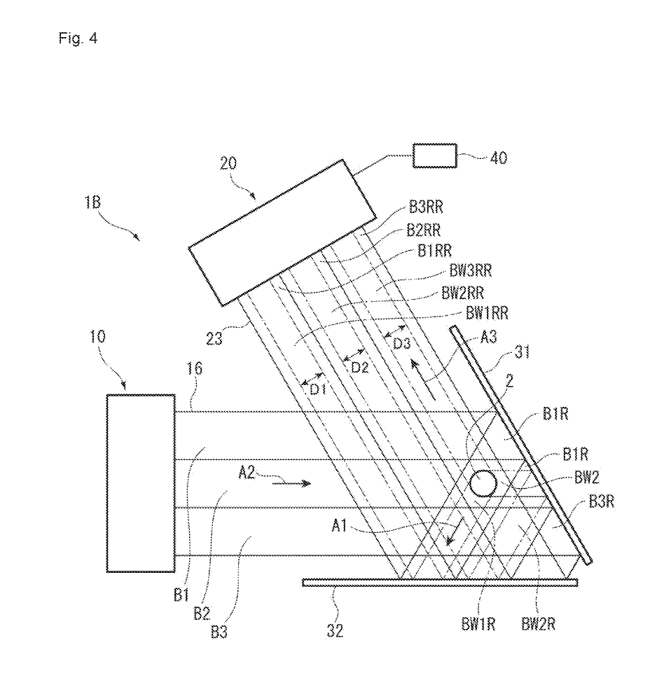

FIG. 4 illustrates a third embodiment according to the present invention. A measuring apparatus 1B of the third embodiment includes the light emitter 10, the photoreceiver 20, and the control apparatus 40 similar to the measuring apparatus 1 in the first embodiment described above. Further, similar to the second embodiment, the two reflection mirrors 31 and 32 are used as the reflector and three regions are assigned to the measuring light beam 16 and the reflection light beam 23.

The difference with the second embodiment mentioned above is the place where the measured object 2 is arranged. In the present embodiment, the measured object 2 is placed on the optical path of the second measuring light beam B2 and in a measuring region on the optical paths of the first reflection light beam B1R and the third re-reflected light beam B3RR. The first reflection light beam B1R is fired in the first direction A1 at the measured object 2 placed in the measuring region, which forms the shadow BW1R and reaches the photoreceiver 20 as the shadow BW1RR of the first re-reflected light beam B1RR. In addition, the measured object 2 forms the shadow BW2 when struck by the second measuring light beam B2 in the second direction A2 and the shadow BW2 reaches the photoreceiver 20 as the shadow BW2R of the second reflection light beam B2R and as the shadow BW2RR of the second re-reflected light beam B2RR. Further, the measured object 2 forms the shadow BW3RR when struck by the third re-reflected light beam B3RR in the third direction A3 and the shadow BW3RR reaches the photoreceiver 20.

As a result, in the reflection light beam 23 received by the photoreceiver 20, the shadows BW1RR, BW2RR, and BW3RR are formed in the first re-reflected light beam B1RR, the second re-reflected light beam B2RR, and the third re-reflected light beam B3RR respectively. Then, it is possible to individually measure the outer diameter D1 in the first direction from the shadow BW1RR, the outer diameter D2 in the second direction from the shadow BW2RR, and the outer diameter D3 in the third direction from the shadow BW3RR.

In the present embodiment, the second direction A2 and the first direction A1 correspond to the main direction and the sub direction of the present invention respectively. In this case, the main measuring light beam of the present invention is the second measuring light beam B2 and the main reflection light beam is the second reflection light beam B2R. In addition, the sub measuring light beam is the first measuring light beam B1 and the sub reflection light beam is the first reflection light beam B1R. The measured object 2 is placed in the measuring region where the optical path of the main measuring light beam (second measuring light beam B2) and the optical path of the sub reflection light beam (first reflection light beam B1R) overlap. Accordingly, the outer diameter D1 in the first direction A1 and the outer diameter D2 in the second direction A2 are measured.

In the meantime, in the present embodiment, the first direction A1 and the third direction A3 also correspond to the main direction and the sub direction of the present invention respectively. In this case, the main measuring light beam of the present invention is the first reflection light beam B1R and the main reflection light beam is the first re-reflected light beam B1RR. In addition, the sub measuring light beam is the third reflection light beam B3R and the sub reflection light beam is the third re-reflected light beam B3RR. The measured object 2 is placed in the measuring region where the optical path of the main measuring light beam (first reflection light beam B1R) and the optical path of the sub reflection light beam (third re-reflected light beam B3RR) overlap. Accordingly, the outer diameter D3 in the third direction A3 and the outer diameter D1 in the first direction A1 are measured. In the present embodiment, in order to measure the outer diameters D1 to D3 in three directions, two sets of the configuration in the present invention are used as described above.

### Other Embodiments

The present invention is not limited to the above-described embodiments, and includes modifications within a scope capable of achieving the advantages of the present invention. In each of the embodiments noted above, the measured object 2 is bar shaped object having a circular cross-section and an outer diameter is measured in different directions. In contrast, the measured object 2 may instead be a bar shaped object having an elliptical, polygonal, or the like cross-section, or be a tubular material, or the like. Alternatively, external dimensions such as a width and a thickness of a board may be measured simultaneously in different directions.

In the present invention, directions of the simultaneous measurement are not limited to the two directions or the three directions as noted above in each of the embodiments and the simultaneous measurement may be performed in a still greater number of directions. However, when scanning by oscillating the beam as in the embodiments noted above, in a case where a plurality of reflection mirrors or the like are used in order to fire the light beam from a plurality of directions, the direction of each light beam entering the photoreceiver 20 must be the same in the end.

The light emitter 10 is not limited to scanning by oscillating the beam like a laser scan micrometer and may be a band shaped line beam. The photoreceiver 20 is not limited to using the photoreceiver element 22 to detect the light beam converged with the collecting lens 21, and may use an array provided with a plurality of photoreceiver elements as in an image sensor micrometer. Further, a collecting mirror may be used instead of the collecting lens 21. An image sensor micrometer may be used instead of a laser scan micrometer.

The present invention relates to an optical measuring method and measuring apparatus for an external dimension and can be used to measure outer diameters of a measured object in a plurality of directions simultaneously.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. An optical measuring method for measuring an external dimension of a measured object, the method comprising:
providing a light emitter emitting a band-shaped measuring light beam which is configured by parallel light beams, wherein at least a main measuring light beam and a sub measuring light beam are defined in the measuring light beam;
providing a reflector reflecting the measuring light beam and forming a reflection light beam, wherein at least a main reflection light beam which is reflected light of the main measuring light beam and a sub reflection light beam which is reflected light of the sub measuring light beam are defined in the reflection light beam;
providing a photoreceiver receiving the reflection light beam are arranged;
arranging the light emitter and the reflector such that an optical axis of the measuring light beam and an optical axis of the reflection light beam intersect;
forming the measuring light beam and the reflection light beam inside the same measuring plane;
placing the measured object in a measuring region on the measuring plane where the main measuring light beam and the sub reflection light beam overlap;
measuring the external dimension in a main direction of the measured object from a shadow of the measured object appearing in the main reflection light beam; and
measuring the external dimension in a sub direction of the measured object from the shadow of the measured object appearing in the sub reflection light beam.

2. An optical measuring apparatus for measuring an external dimension of a measured object, the apparatus comprising:
a light emitter configured to emit a band-shaped measuring light beam which is configured by parallel light beams, the measuring light beam including at least a main measuring light beam and a sub measuring light beam;
a reflector configured to reflect the measuring light beam and form a reflection light beam including at least a main reflection light beam which is reflected light of the main measuring light beam and a sub reflection light beam which is reflected light of the sub measuring light beam, wherein the light emitter and the reflector are arranged such that:
an optical axis of the measuring light beam and an optical axis of the reflection light beam intersect, and
the measuring light beam and the reflection light beam are formed inside the same measuring plane;
a photoreceiver configured to receive the reflection light beam; and
a measuring region where the main measuring light beam and the sub reflection light beam overlap on the measuring plane, the measuring region configured to accept the measured object.
